(19) United States
(12) Patent Application Publication
(10) Pub. No.: US 2025/0147449 A1
(43) Pub. Date: May 8, 2025

(54) IMAGE FORMING APPARATUS

(71) Applicant: CANON KABUSHIKI KAISHA, Tokyo (JP)

(72) Inventor: Ryosuke Kosone, Chiba (JP)

(21) Appl. No.: 18/916,841

(22) Filed: Oct. 16, 2024

(30) Foreign Application Priority Data
Nov. 8, 2023 (JP) 2023-191063

(51) Int. Cl. G03G 15/06; G03G 15/02

(52) U.S. Cl. CPC G03G 15/065; G03G 15/0266; G03G 2215/0607

(57) ABSTRACT

An image forming apparatus includes an image bearing member, a charging portion, a latent image forming portion, a developer bearing member for bearing and feeding a developer including toner and an external additive having the same polarity as a charging polarity of the toner, and a developing bias application portion for applying a developing bias in which a DC voltage is superposed with an AC voltage to the developer bearing member. In a continuous image forming job, the developing bias application portion applies the developing bias to the developer bearing member so that an absolute value of a difference between a predetermined charging potential and the DC voltage in a non-developing period is larger than an absolute value of that in a developing period and a peak-to-peak voltage of the AC voltage in the non-developing period is larger than that in the developing period.

### FIELD OF THE INVENTION AND RELATED ART

The present invention relates to an image forming apparatus.

In an electrophotographic image forming apparatus, an image is formed on a recording material by using a two-component developer which is a mixture of nonmagnetic toner and a magnetic carrier. An external additive whose charging polarity is the same polarity as toner is added to the toner in order to ensure fluidity and charge imparting property of the toner. The developer is supplied from a developer container to a photosensitive drum by a developing sleeve according to application of a developing voltage which is superimposed by an AC voltage and a DC voltage, and the toner which is included in the developer develops an electrostatic latent image which is formed on a surface of the photosensitive drum. The toner which remains on the surface of the photosensitive drum after development is removed from the photosensitive drum by a drum cleaner.

As progress of image formation on the recording material, the concentration of the external additive in the developer container increases, since the toner is consumed accompanied by development and the external additive may separate from the toner by stirring and conveying the developer in the developer container. For this reason, in an apparatus disclosed in Japanese Laid-Open Patent Application (JP-A) 2019-66547, in order to maintain concentration of an external additive at an appropriate level, it is disclosed that the concentration of the external additive in the developer container is reduced by discharging mainly the external additive which is charged with the same polarity as the toner, from the developer container to the photosensitive drum when a job is completed or when a job is interrupted, which are image forming operations. In the apparatus disclosed in JP-A 2019-66547, after an image which has achieved at a predetermined density is formed, the external additive in the developer container is discharged to the photosensitive drum by rotating the developing sleeve while a peak-to-peak voltage of an AC voltage is increased compared to during image formation. The external additive which has been discharged to the photosensitive drum is removed from the photosensitive drum by a drum cleaner along with the toner.

However, conventionally, some of the external additive on the photosensitive drum may not be removed by the drum cleaner, then, it may be remained on the photosensitive drum and may be carried by the photosensitive drum, when development is performed while the concentration of the external additive in the developer container is relatively high before the external additive is discharged as described above. The external additive forms an electric field which attracts the toner by its own electrical charge, and an area of the photosensitive drum, on which a large amount of external additive is remained, is more likely to attract the toner than other areas. Therefore, even though a uniform density image should be formed in a normal condition, it may cause an image defect which is called a ghost image in which there is a difference in density due to the external additive.

### SUMMARY OF THE INVENTION

A principal object of the present invention is to provide an image forming apparatus capable of suppressing an occurrence of an image defect.

Another object of the present invention is to provide an image forming apparatus comprising: an image bearing member; a charging portion configured to charge the image bearing member to a predetermined charging potential; a latent image forming portion configured to form an electrostatic latent image on the image bearing member charged to the predetermined charging potential by the charging portion; a developer bearing member configured to bear and feed a developer including toner and an external additive having the same polarity as a charging polarity of the toner in a developing area where the electrostatic laten image formed on the image bearing member by the latent image forming portion is developed; and a developing bias application portion configured to apply a developing bias in which a DC voltage is superposed with an AC voltage to the developer bearing member, wherein in a case where in a continuous image forming job in which the image is formed on a plurality of recording materials including a first recording material and a second recording material subsequent to the first recording material, a period from when a leading end of a first electrostatic latent image for the first recording material passes through the developing area until a trailing end of the first electrostatic latent image passes through the developing area is defined as a first period, and a period from when the trailing end of the first electrostatic latent image passes through the developing area until a leading end of a second electrostatic latent image for the second recording material passes through the developing area, and the latent image forming portion does not form the electrostatic latent image on the image bearing member is defined as a second period, the developing bias application portion applies the developing bias to the developer bearing member so that an absolute value of a difference between the predetermined charging potential and the DC voltage in the second period is larger than an absolute value of a difference between the predetermined charging potential and the DC voltage in the first period, and a peak-to-peak voltage of the AC voltage in the second period is larger than a peak-to-peak voltage of the AC voltage in the first period.

Further features of the present invention will become apparent from the following description of exemplary embodiments with reference to the attached drawings.

### BRIEF DESCRIPTION OF THE DRAWINGS

FIG. 1 is a schematic view showing a configuration of an image forming apparatus according to an embodiment.

FIG. 2 is a sectional view showing a developing device.

FIG. 3 is a schematic view showing a circulating passage of a developer.

FIG. 4 is a block diagram showing a control system related to a toner image formation.

Part (a) of FIG. 5 is a diagram showing a waveform of a developing voltage to which is applied during development, and part (b) of FIG. 5 is a diagram showing a waveform of a developing voltage to which is applied during non-development.

FIG. 6 is a flow chart showing an image forming process according to a first embodiment.

Part (a) and part (b) of FIG. 7 are drawings showing toner images which are formed on recording materials in order to obtain experimental results, part (a) of FIG. 7 shows a solid image of a vertical stripe, and part (b) of FIG. 7 shows a solid image of a vertical stripe and a half-tone image of a horizontal stripe.

FIG. 8 is a graph showing differences in reflection density of the experimental results.

FIG. 9 is a flow chart showing an image forming process according to a second embodiment.

### DESCRIPTION OF THE EMBODIMENTS

### First Embodiment

### <Image Forming Apparatus>

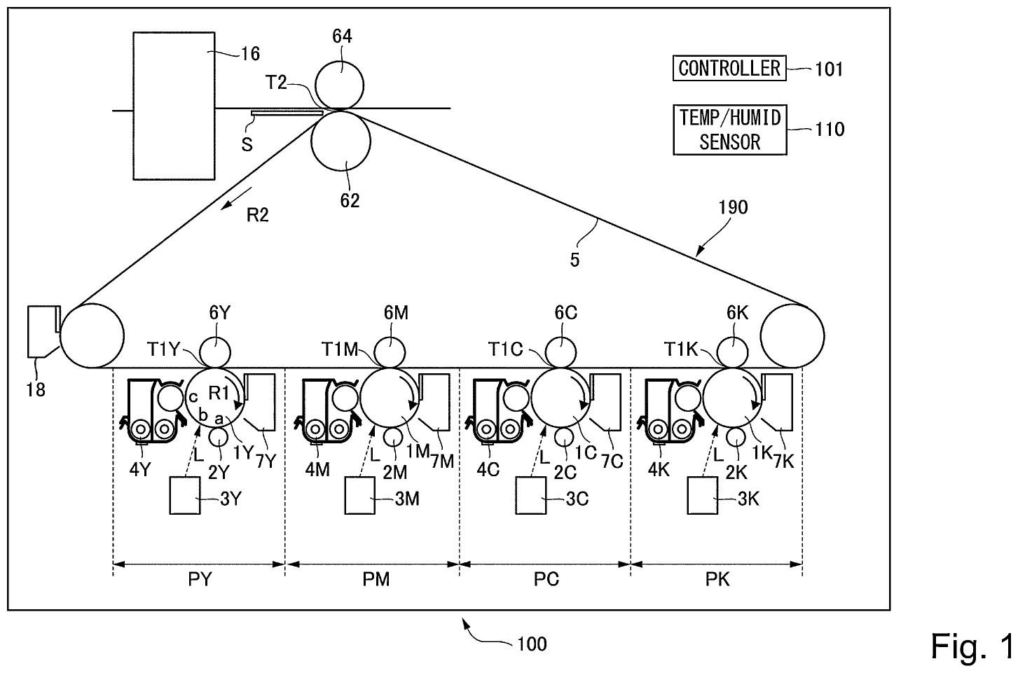

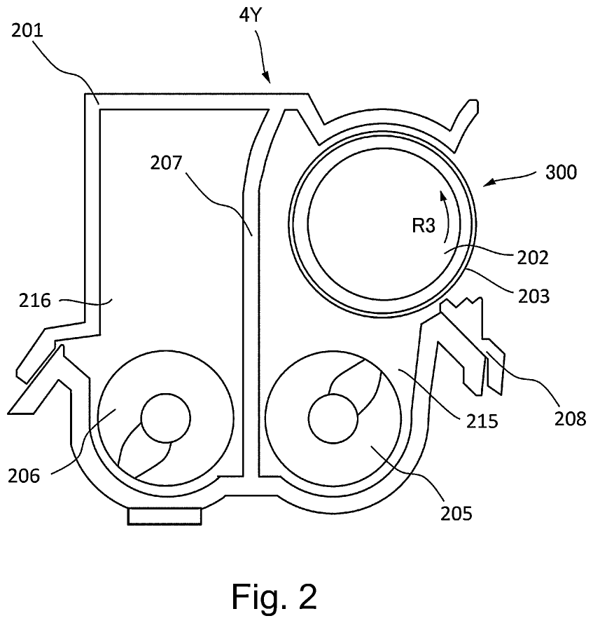

In the following, an embodiment of the present invention will be described with reference to Figures. First, a configuration of an image forming apparatus according to the embodiment will be described by using FIG. 1. The image forming apparatus 100 which is shown in FIG. 1 is a color image forming apparatus of an intermediary transfer tandem system, in which four color image forming portions PY, PM, PC and PK are disposed opposing an intermediary transfer belt 5.

The image forming apparatus 100 is provided with four image forming portions, PY, PM, PC and PK, which form toner images of yellow, magenta, cyan and black. The image forming portions PY, PM, PC and PK, include photosensitive drums 1Y, 1M, 1C and 1K respectively, and the photosensitive drums from 1Y to 1K form toner images of each color. The toner images which are borne on the photosensitive drums from 1Y to 1K are transferred to a recording material S via the intermediary transfer belt 5. As the recording material S, various types of sheet materials may be used, including paper such as plain paper, thick paper, rough paper, uneven paper and coated paper, plastic film and cloth.

The image forming portions from PY to PK are configured similarly, except that colors of toners which are used for development are different, so in the following, the yellow image forming portion PY will be described as an example. The image forming portion PY includes a photosensitive drum 1Y, as well as a charging roller 2Y, an exposure device 3Y, a developing device 4Y, a primary transfer roller 6Y and a drum cleaner 7Y.

The photosensitive drum 1Y as an image bearing member is rotationally driven by an unshown driving motor in a rotational direction of the intermediary transfer belt 5. The charging roller 2Y as a charging portion uniformly charges a surface of the photosensitive drum 1Y by applying a charging voltage. A contact portion between the charging roller 2Y and the photosensitive drum 1Y is a charging position a. An exposure device 3Y (latent image forming portion) as an exposure portion irradiates the photosensitive drum 1Y with laser light L which is modulated according to image information, and forms an electrostatic latent image on the surface of the photosensitive drum 1Y. A position where the laser light L is irradiating on the photosensitive drum 1Y is an exposure position b.

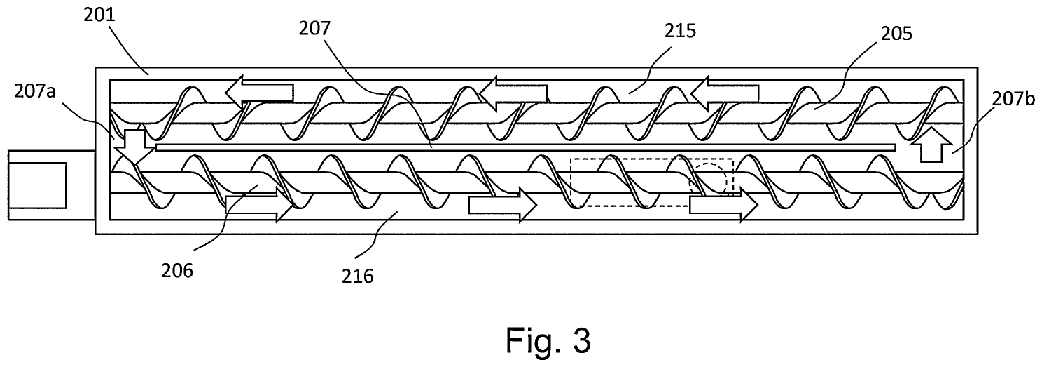

The developing device 4Y accommodates a developer which includes toner, and by applying developing voltage, the developing device 4Y supplies the toner to the photosensitive drum 1Y and develops the electrostatic latent image into a toner image. The developing device 4Y will be specifically described below (see FIG. 2 and FIG. 3). The toner image which is formed on the photosensitive drum 1Y is primarily transferred to the intermediary transfer belt 5 at a primary transfer nip portion T1Y by a primary transfer roller 6Y to which primary transfer voltage is applied. The toner which remains on the photosensitive drum 1Y without being transferred to the intermediary transfer belt 5 at the primary transfer nip portion T1Y is removed by the drum cleaner 7Y. The drum cleaner 7Y as a cleaning member contacts the photosensitive drum 1Y and removes the toner which remains on the photosensitive drum 1Y after transferring the toner image to the intermediary transfer belt 5.

The intermediary transfer belt 5 is rotationally driven in a direction of an arrow R2 in the figure. The image forming operations which are described above are performed in parallel in each image forming portion from PY to PK, and in the primary transfer nip portions from T1Y to T1K, the four color toner images are superimposed and multiple transferred on the intermediary transfer belt 5, and a full color toner image is formed. The toner image is borne on the intermediary transfer belt 5 and conveyed to a secondary transfer nip portion T2 which is formed between an outer secondary transfer roller 64 and an inner secondary transfer roller 62. The toner image which is borne on the intermediary transfer belt 5 is secondarily transferred to the recording material S by applying a secondary transfer voltage to the outer secondary transfer roller 64. In the embodiment, the primary transfer rollers from 6Y to 6K, the intermediary transfer belt 5, the outer secondary transfer roller 64 and the inner secondary transfer roller 62 configure a transfer device 190 which transfers the toner image which is formed on the photosensitive drum from 1Y to 1K to the recording material S. The toner which remains on the intermediary transfer belt 5 after secondary transfer is removed by a belt cleaner 18. The recording material S, to which the toner image is transferred, is conveyed to a fixing device 16 and is pressed and heated by the fixing device 16. In this way, the toner image is fixed to the recording material S.

### <Developing Device>

Next, the developing device 4Y will be described by using FIG. 2 and FIG. 3, with reference to FIG. 1. As shown in FIG. 2, the developing device 4Y includes a developer container 201, a developing sleeve 203, a conveying screw 205, a stirring screw 206 and a regulating blade 208.

As shown in FIG. 2, in the developer container 201, an opening 300 is formed in an area opposing the photosensitive drum 1Y. The developing sleeve 203 as a developer bearing member is rotatably arranged in the developer container 201 so that a part of its outer surface is exposed from the opening 300 of the developer container 201. In a downstream of an exposure position b with respect to a rotational direction of the photosensitive drum 1Y (downstream with respect to a direction of an arrow R1), a position in which the developing sleeve 203 is opposed to the photosensitive drum 1Y is a developing position c (developing area) as shown in FIG. 1. The developing sleeve 203 is rotationally driven by an unshown motor so that a surface of the developing sleeve 203 moves in the same direction as a rotational direction of the photosensitive drum 1Y at the developing position c.

In a rotational direction of the developing sleeve 203 (a direction of an arrow R3), a regulating blade 208 is arranged on an upstream side of the opening 300 of the developer container 201. The regulating blade 208 regulates a height of a magnetic brush of the developer which is formed on the developing sleeve 203 by a magnetic force of the magnet 202, and forms a developer layer on the developing sleeve 203. The developer layer on the developing sleeve 203 slides the surface of the photosensitive drum 1Y at the developing position c.

The developing sleeve 203 is formed of a non-magnetic material, and the developer is conveyed to the developing position c while the developer is borne on the surface by the magnetic force of the magnet 202 which is non-rotationally arranged inside. When the developer is supplied from the developing sleeve 203 to the photosensitive drum 1Y at the developing position c, the electrostatic latent image which is formed on the photosensitive drum 1Y is developed into the toner image. That is, when the toner in the developer which is conveyed to the rotating developing sleeve 203 selectively adheres in response to the electrostatic latent image on the photosensitive drum 1Y by an electric field of the developer voltage, the electrostatic latent image on the photosensitive drum 1Y is developed as the toner image. At that time, the developer which passes through the developing position c without being supplied to the photosensitive drum 1Y returns to the developer container 201 according to a rotation of the developing sleeve 203, and is collected by separating it from the developing sleeve 203 in a developing chamber 215.

An inside of the developer container 201 is divided into the developing chamber 215 and a stirring chamber 216, which are possible to accommodate the developer, by a partition wall 207 which extends in a vertical direction (longitudinal direction) in the drawing at a substantially center portion. The conveying screw 205 is rotatably arranged in the developing chamber 215, and a stirring screw 206 is rotatably arranged in the stirring chamber 216.

As shown in FIG. 3, in the developer container 201, partition wall opening portions (207a, 207b) for delivering the developer between the developing chamber 215 and the stirring chamber 216 are formed on one end side and the other end side of the partition wall 207 with respect to a longitudinal direction, which is provided between the conveying screw 205 and the stirring screw 206. When the developing chamber 215 and the stirring chamber 216 are communicated via the partition wall opening portions (207a, 207b), a circulating passage of the developer which circulates between the developing chamber 215 and the stirring chamber 216 is formed. The conveying screw 205 and the stirring screw 206 convey the developer in opposite directions each other along a direction of a rotational axis of the developing sleeve 203. Therefore, the developer is delivered from the developing chamber 215 to the stirring chamber 216 through the partition wall opening portion 207a, and is delivered from the stirring chamber 216 to the developing chamber 215 through the partition wall opening portion 207b.

The conveying screw 205 conveys the developer in the developing chamber 215. When the conveying screw 205 rotates, the developer in the developing chamber 215 is conveyed along the conveying screw 205, and at that time, a part of the developer is supplied to the developing sleeve 203. On the other hand, the stirring screw 206 stirs and conveys a supplement which contains the toner which is supplied at a suitable time from a toner supply device (unshown) and the developer in the stirring chamber 216, and equalizes a toner concentration of the developer which is accommodated in the developer container 201.

The developer container 201 accommodates a two-component developer which includes negatively charged non-magnetic toner and a positively charged magnetic carrier (hereinafter referred to as a magnetic carrier). Non-magnetic toner is made by crushing or polymerizing resins such as polyester, styrene acrylic which include a coloring agent, a wax, etc. The magnetic carrier is made by applying a resin coating to a surface layer of a core which is made of a resin particle which is mixed with a ferrite particle or a magnetic powder. The toner which is contained in the developer is charged with a negative electric charge as the developer is mixed and conveyed inside the developer container 201 by the conveying screw 205 and the stirring screw 206. In the embodiment, by supplying the toner which is charged to the same polarity as a charging polarity of the photosensitive drum 1Y to the electrostatic latent image, an inversion development method is applied in which the electrostatic latent image is developed into the toner image. Further, the toner is added with fine particle external additives such as silica and titanium oxide, for example, in order to ensure fluidity and a charge imparting property. An external additive which is added to the toner and an external additive which is separated from the toner are charged with the same polarity (negative polarity in this case) as the toner's charging polarity by being mixed and conveyed in the developer container 201.

### <Control Portion>

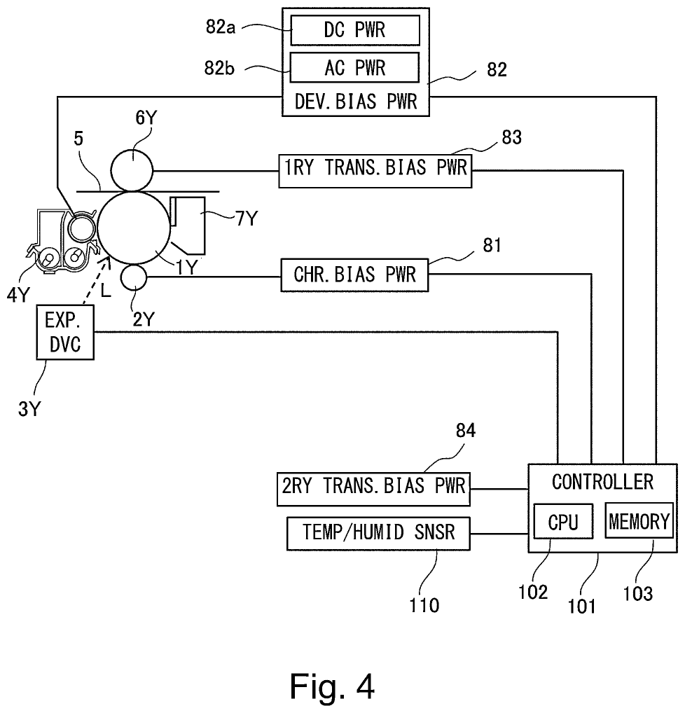

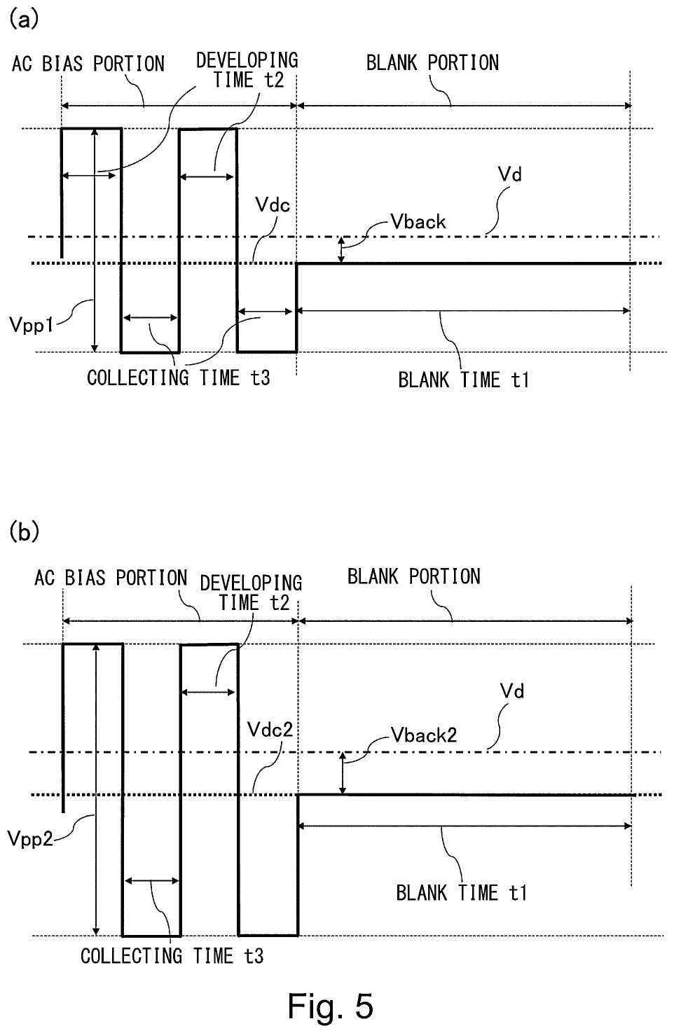

As shown in FIG. 1, the image forming apparatus 100 includes a control portion 101 which controls the image forming apparatus 100. The control portion 101 will be described by using FIG. 4. Incidentally, in addition to items which are illustrated, the control portion 101 is connected to various devices such as motors and power sources which operate the image forming apparatus 100, however, these are not a principal object of the present invention, so they are omitted from illustrating and description.

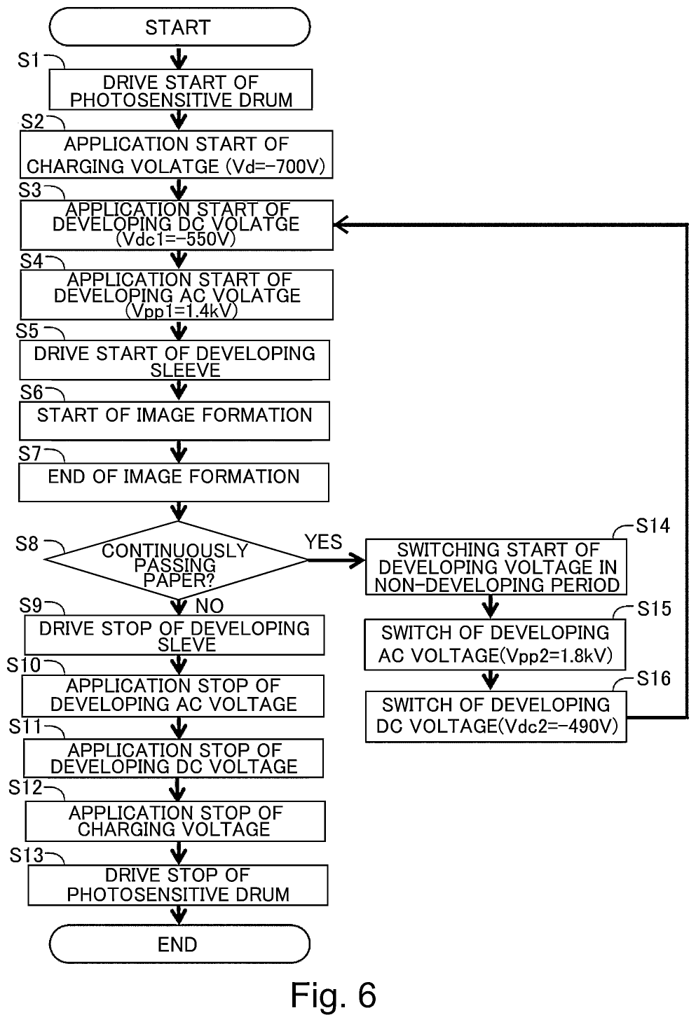

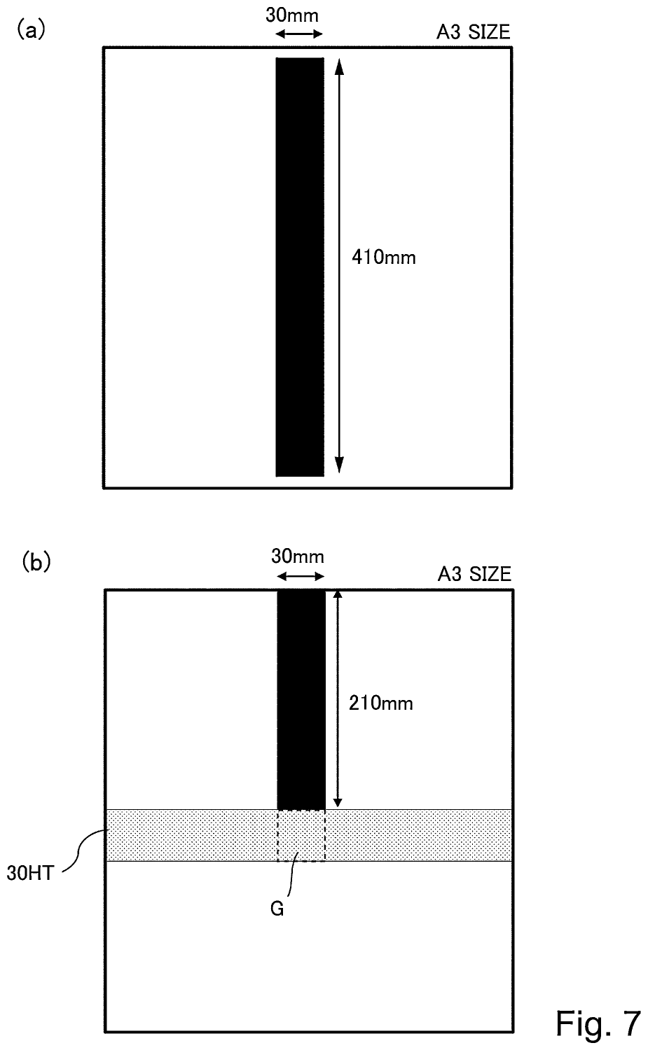

As shown in FIG. 4, the control portion 101 includes a CPU (Central Processing Unit) 102 and a memory 103 such as ROM and RAM, and controls various motors and the power sources based on image information and various sensor inputs. The memory 103 stores various programs, such as “image forming processing” for example (see FIG. 6 which will be described below), and various data, such as the developing voltage (DC voltage value and AC voltage value which will described below) which are applied during developing and non-developing, respectively. The CPU 102 is capable of executing various programs which are stored in the memory 103, and operates the image forming apparatus 100 by executing various programs.

In the specification, a term “developing time” refers to a period during which an image area, corresponding to the recording material S onto which the toner image is transferred, of a surface of the photosensitive drum 1Y, passes through the developing position c in a continuous image forming job in which an image is formed on a plurality of recording materials S (that is, in the continuous image forming job in which an image is formed on a plurality of recording materials, including a first recording material and a second recording material which follows the first recording material, a period from a leading end of a first electrostatic latent image for the first recording material passing through the developing area to a trailing end of the first electrostatic latent image passing through the developing area). A term “non-developing time” refers to a period during which a non-image area, which is positioned between two image areas which are continuous with respect to the rotational direction of the photosensitive drum 1Y among the surface of the photosensitive drum 1Y, passes through the developing position c, in a continuous image forming job in which images are formed continuously on the plurality of recording materials S (that is, in the continuous image forming job which forms an image on the plurality of recording materials, which include the first recording material and the second recording material which follows the first recording material, a period from a time when the trailing end of the first electrostatic latent image for the first recording material passes through the developing area to a time when the leading end of the second electrostatic latent image for the second recording material passes through the developing area, and a period when the developing device 3Y is not forming the electrostatic latent image on the surface of the photosensitive drum 1Y). That is, the non-developing time is a period when the non-image area corresponding to a space (so-called sheet interval) between a preceding recording material and a subsequent recording material S on the surface of the photosensitive drum 1Y passes through the developing position c (developing area).

Further, the continuous image forming job is a period from a start of image formation to a completion of an image forming operation, based on a print signal which continuously forms an image on the plurality of recording materials S. Specifically, it refers to a period from a pre rotation (a preparation operation before image formation) after receiving a print signal (input of an image forming job) to a post rotation (operation after image formation), and includes an image forming period and sheet intervals. Incidentally, for example, in a case that one job is followed by another job consecutively, these are determined as a single continuous image forming job.

The control portion 101 is connected to a temperature and humidity sensor 110, a charging bias power source 81, a developing bias power source 82, a primary transfer bias power source 83 and a secondary transfer bias power source 84. The temperature and humidity sensor 110 as a humidity detection portion, is arranged in a main body of the image forming apparatus (see FIG. 1), and detects a temperature and relative humidity (hereinafter simply referred to as “humidity”) in the main body of the image forming apparatus.

The charging bias power source 81 applies a charging voltage to the charging roller 2Y and uniformly charges the surface of the photosensitive drum 1Y with a negative charge electric potential (Vd). In the embodiment, when the surface of the photosensitive drum 1Y is uniformly charged to a charging potential of “−700V” by applying a DC charging voltage using the charging bias power source 81. The exposure device 3Y scans and exposures the surface of the charged photosensitive drum 1Y with a laser beam. With the laser scanning exposure, a potential of an area on the photosensitive drum 1Y which is irradiated by the laser light is lowered, and an electrostatic latent image is formed on the photosensitive drum 1Y. In this way, when the charged photosensitive drum 1Y is exposed by the exposure device 3Y, a potential of an image portion (also called as the exposure potential) in which the electrostatic latent image is formed on the photosensitive drum 1Y changes to, for example, “−150V”. A potential of a non-image portion in which an electrostatic latent image is not formed since it is not exposed by the exposure device 3Y in the photosensitive drum 1Y remains at a charging potential of “−700V”.

The developing bias power source 82 as a developing power source, is capable of applying a developing voltage to the developing sleeve 203. A developing voltage which is applied to the developing sleeve 203 is a superimposed voltage in which a DC voltage (Vdc) and an AC voltage (Vac). The developing bias power source 82 includes a DC power source 82a and an AC power source 82b. The developing bias power source 82 applies a superimposed voltage, that for example, a DC voltage of “−550V” which is output from a DC power source 82a and an AC voltage in which frequency is “11 kHz” and peak-to-peak voltage is “1.4 kV” which is output from the AC power source 82b are superimposed, to the developing sleeve 203 as the developing voltage during development. The DC voltage (Vdc) of developing voltage is a potential between the charging potential (Vd) and the exposed area potential. The primary transfer bias power source 83 applies a positive primary transfer voltage to the primary transfer roller 6Y in order to primary transfer. The secondary transfer bias power source 84 applies a positive secondary transfer voltage to the outer secondary transfer roller 64 in order to secondary transfer.

Part (a) of FIG. 5 and part (b) of FIG. 5 show a waveform of the developing voltage which is applied by the developing bias power source 82. Part (a) of FIG. 5 shows the waveform of the developing voltage which is applied during development, and part (b) of FIG. 5 shows the waveform of the developing voltage which is applied during non-development.

As mentioned above, the developing bias power source 82 applies a developing voltage in which an AC voltage is superposed on a DC voltage, to the developing sleeve 203. The AC voltage of the developing voltage is a square wave with a frequency of “11 kHz”. As shown in part (a) of FIG. 5 and part (b) of FIG. 5, the developing voltage is provided with a blank portion in which only DC voltage is remained by thinning out the AC voltage intermittently. In the specification, in a case that the AC voltage is not thinned out, a rectangular wave pulse which was existed in a portion corresponding to the blank portion, that is, a pulse which becomes a blank by thinning out of the AC voltage (pulse which does not exist) is called a “blank pulse”. Further, a portion which becomes the DC voltage by thinning out the AC voltage intermittently is called a “blank portion”.

Therefore, the developing voltage, to which the developing bias power source 82 applies, is a waveform in which an AC bias portion in which an DC voltage (Vdc) is superimposed on an AC voltage and a blank portion in which only a DC voltage (Vdc) is applied which follows the AC bias portion are one cycle, as shown in part (a) of FIG. 5 and part (b) of FIG. 5.

In the embodiment, a double blank pulse waveform (hereinafter referred to as WBP) in which the blank portion is provided after the AC bias portion which includes a two-cycle (four-pulse) rectangular wave is used as the developing voltage. Incidentally, in the specification, the number of pulses in a rectangular wave is counted as one pulse per half cycle of the rectangular wave. Further, a time of the blank portion in one cycle of the developing voltage is defined as a blank time t1. Further, a total application time of a maximum voltage which occurs in an electric field (pulse) on a developing side of the AC bias portion in one cycle of the developing voltage is defined as a developing time t2, and a total application time of a minimum voltage which occurs in an electric field on a collection side is defined as a collection time t3. Furthermore, a ratio (duty ratio) of the electric field on the developing side to the electric field on the collecting side in the AC bias portion is set to 50%. Here, the electric field on the developing side is an electric field in which the toner is moved from the developing sleeve 203 to the photosensitive drum 1Y by the AC bias portion during one cycle of the developing voltage. Further, the electric field on the collecting side is an electric field in which the toner is pulled back from the photosensitive drum 1Y to the developing sleeve 203 by the AC bias portion during one cycle of the developing voltage.

During development, a total voltage (equivalent to an amplitude of the AC bias portion) of the developing side (developer adding side) and the collecting side (developer pulling back side) of the AC bias portion is defined as “Vpp1”, and here as an example, “Vpp1” is set to be “1.4 kV”. During development, a potential difference (hereinafter referred to as “Vback”) is set between a potential of the non-image area of the photosensitive drum 1Y where no electrostatic latent image is formed and a potential of the developing sleeve 203 is set, and a developing voltage according to “Vback” is applied. “Vback” is an absolute value of a potential difference between a potential of the non-image area, that is, a charging potential (Vd) of the photosensitive drum 1Y, and a potential of the developing sleeve 203. As an example, in a case that a charging potential of the photosensitive drum 1Y is “−700V”, “Vback” is set to be “150V” and the DC voltage of the developing voltage becomes “−550V”. “Vback” during development forms an electric field (electric field on collecting side) which pulls back the toner from the photosensitive drum 1Y to the development device 4Y, more specifically the developing sleeve 203. This is to prevent causing image defect which is called “fogging image” due to so-called “fogging” in which the toner is adhered to the non-image area of the photosensitive drum 1Y.

As described above, the developer used in the embodiment is a two-component developer which includes the non-magnetic toner, the magnetic carrier and the external additive which is added to the toner. When developing the image area where the electrostatic latent image is formed on the photosensitive drum 1Y by the developer, the toner of the developer which is borne on the developing sleeve 203 in the developing device 4Y is moved to the photosensitive drum 1Y and used for development. At this time, the external additive which is added to the toner is also moved to the photosensitive drum 1Y. Further, a part of the external additive which is added to the toner may separate from the toner during stirring and conveying.

The external additive which is moved to the photosensitive drum 1Y is transferred to the intermediary transfer belt 5 along with the toner when the toner is primary transferred to the intermediary transfer belt 5, however, since particle size of the external additive is small and non-electrostatic adhesive force of the external additive is strong, a part of the external additive remains in the image area of the photosensitive drum 1Y after the primary transfer. Further, the toner which remains on the photosensitive drum 1Y after the primary transfer is removed by the drum cleaner 7Y (see FIG. 1), however, since particle size of the external additive is small and non-electrostatic adhesive force of the external additive is strong, the external additive easily remains on the photosensitive drum 1Y without completely being cleaned.

When a charging voltage is applied to the photosensitive drum 1Y on which external additive is remained by using the charging roller 2Y, the area where the external additive remains attracts more toner than the area where no external additive remains, caused by the external additive which is charged with a negative polarity. As a result, when developing the next recording material S, an amount of the toner which moves from the developing sleeve 203 to the photosensitive drum 1Y may increase in the area where the external additive remains, more than was intended. In particular, in a case that the same or similar image patterns are formed continuously on the plurality of recording materials S, a large amount of the external additive is accumulated in the area where the external additive remains in the image portion. Then, when an image like a halftone image is formed, a ghost image may be formed since a difference in density is occurred in the image portion of a same or similar image pattern.

And, in the embodiment, a peak-to-peak voltage (Vpp) is made higher and “Vback” is made higher in the developing voltage which is applied during non-development than in the developing voltage which is applied during development, it is possible to collect the external additive to the developing device 4Y from the photosensitive drum 1Y. In the following, an image forming process according to the embodiment, which realizes that, will be described by using FIG. 6 with reference to FIG. 4. “Image forming process” which is shown here is started in response to acquisition of a start command for a continuous image forming job by a control portion 101.

### <Image Forming Process>

As shown in FIG. 6, when the control portion 101 receives a start command of a continuous image forming job from an unshown operation portion or an external device (for example, a personal computer), the control portion 101 controls a driving motor (unshown) and starts rotational driving of the photosensitive drum 1Y (S1). The control portion 101 controls the charging bias power source 81 and starts applying a charging voltage to set a charging potential of the photosensitive drum 1Y (charging potential Vd1 during development) to “−700V”, for example (S2). And the control portion 101 sets a DC voltage as a developing voltage to be applied during development to, for example, “−550V” (first DC voltage, DC Vdc1 during development), and a peak-to-peak voltage to, for example, “1400V” (first peak-to-peak voltage, AC voltage Vpp1 during development), and applies to the developing bias power source 82 (S3, S4). At this time, the “Vback1” during development is “150V (700V-550V)” (see part (a) of FIG. 5). And the control portion 101 controls an unshown motor, and starts rotational driving of the developing sleeve 203 (S5). Then, the control portion 101 starts to convey the recording material S and performs image formation on the recording material S (S6). The control portion 101 determines whether there is a subsequent recording material S in which continuous image formation is performed (S8), after each image formation on the recording material S is completed (S7).

In a case that there is no subsequent recording material S (NO in S8), the control portion 101 stops rotational driving of the developing sleeve 203 (S9). Further, the control portion 101 stops applying the AC voltage and the DC voltage by the developing bias power source 82 (S10, S11). And the control portion 101 stops applying the charging voltage by the charging bias power source 81 (S12), and then stops rotational driving of the photosensitive drum 1Y (S13), and completes the image forming process.

On the other hand, in a case that there is a subsequent recording material S (YES in S8), the control portion 101 switches a developing voltage to a developing voltage which is applied during non-development (S14). The control portion 101 sets a peak-to-peak voltage to, for example, “1.8 kV” (second peak-to-peak voltage, AC voltage Vpp2 during non-development) as a developing voltage which is applied during non-development and the DC voltage to, for example, “−490V” (second DC voltage, DC voltage Vdc2 during non-development), and is applied to the developing bias power source 82 (S15, S16). At this time, “Vback2” during non-development is “210V (700V-490V)” (see part (b) of FIG. 5). After that, the control portion 101 returns to a process of a step S3 in order to return to a developing voltage during development for the subsequent recording material S.

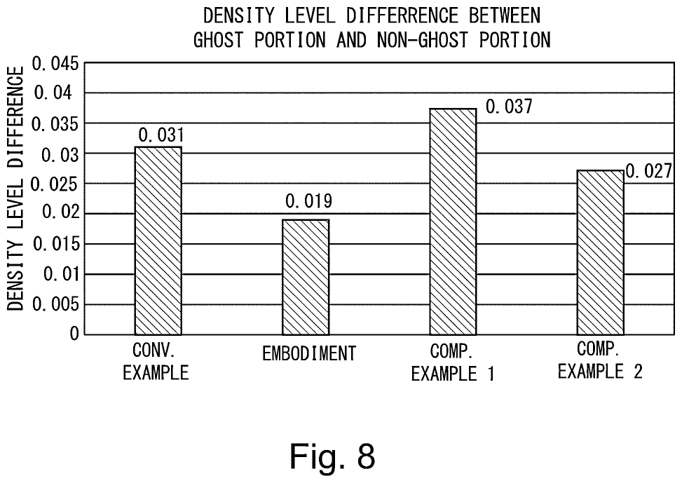

Effects of the embodiment will be described by comparing experimental results of a conventional example and comparative examples. Part (a) of FIG. 7 and part (b) of FIG. 7 are views showing toner images which are formed on the recording material S in order to obtain the experimental results. FIG. 8 is a graph showing an experimental result of the embodiment and the experimental results of the conventional example and the comparative examples. As will be described below, the inventors conducted an experiment to research a difference in density between reflection density in an area where a solid image and a halftone image which are formed on the recording material S by using an image forming portion PK are overlapped, and reflection density in an area where the solid image and the halftone image are not overlapped.

First of all, in the experiment, black images whose image ratios are 30% are output on 200 sheets of the recording materials S whose size is A4 by using the image forming portion PK. The developing voltage at this time is set to same as the developing voltage (Vpp, Vback) of the conventional example which is shown in Table 1. Therefore, the concentration of the external additive in the developer container 201 is increased. Subsequently, a solid image with a vertical band in which a main scanning width is 30 mm and a sub-scanning width is 410 mm and an image ratio is 100% is formed continuously on five sheets of the recording material S whose size is A3 by the image forming portion PK, as shown in part (a) of FIG. 7. The developing voltage when the solid image is formed is set to the same as the developing voltage (Vpp, Vback) of the conventional example which is shown in Table 1. Next, continuously, as shown in part (b) of FIG. 7, an image of a horizontal band in which a black half-tone of 30HT is formed at a trailing edge of the solid image of the vertical band is formed on one sheet of the recording material S. When the images in part (a) of FIG. 7 and part (b) of FIG. 7 are formed continuously, the developing voltages during non-development are set to as the developing voltages (Vpp2, Vback2) for the conventional example, the embodiment, the comparative example 1 and the comparative example 2 which are shown in Table 1.

TABLE 1

| | Conventional | | Comparative | Comparative |
|---|---|---|---|---|
| | Example | Embodiment | Example 1 | Example 2 |
| Vpp2 | 1400 V | 1800 V | 1800 V | 1400 V |
| Vback2 | 150 V | 210 V | 150 V | 210 V |

As shown in Table 1, in the conventional example, the developing voltage (Vpp2, Vback2) during non-development is the same as the developing voltage (Vpp1, Vback1) during development. In the comparative example 1, the peak-to-peak voltage (Vpp2) during non-development is greater than the peak-to-peak voltage (Vpp1) during development. In the comparative example 2, “Vback2” during non-development is greater than “Vback1” during development. As described above, the developing voltage during non-development is greater than the developing voltage during development in the embodiment. In a case of the embodiment, since an electric field on the collecting side needs to be increased in accordance with an increase in an amount of a flying toner due to an increase in the peak-to-peak voltage (Vpp2), a setting value of Vback2 is also increased.

And, a reflection density of an overlapping portion G in an area surrounded by dotted lines immediately after the solid image of the vertical band in the 30 HT halftone image in an image shown in part (b) of FIG. 7, and a reflection density of a non-overlapping portion in which the solid image is not formed immediately before the 30 HT half-tone image are measured, and differences of reflection densities between the overlapping portion G and non-overlapping portion are determined. The differences of the reflection densities of the experimental results are shown in FIG. 8. As shown in FIG. 8, the difference of the reflection density of the conventional example is “0.031”. In the embodiment, the difference of the reflection density is “0.019”. In the comparative example 1, the difference of the reflection density is “0.037”. In the comparative example 2, the difference of the reflection density is “0.027”. That is, when both Vpp2 and Vback2 are greater such that the peak-to-peak voltage “Vpp2=1.8 kV” and “Vback2=210V”, it is possible to reduce the difference of the reflection density compared to the conventional example, the comparative example 1 and the comparative example 2. In other words, it is possible to suppress occurring a ghost image.

A reason why the difference of the density is greater in the comparative example 1 is that the electric field on the developing side becomes stronger by increasing only the peak-to-peak voltage (Vpp2). As the electric field on the developing side becomes stronger, the external additive may move from the developing device 4K together with the toner and accumulate on the photosensitive drum 1K even during non-development. When the external additive accumulates on the photosensitive drum 1K, the potential becomes smaller than an exposure potential in absolute value in a range where the electrostatic latent image which is formed during development of a next recording material S overlaps with an area where the external additive is accumulated, and more toner adheres and the difference of the density becomes greater.

In comparative example 2, the electric field on the collecting side becomes strong by increasing only “Vback2”, and the external additive is collected from the photosensitive drum 1K to the developing device 4K, so the difference of the density becomes smaller than in the conventional example and the comparative example 1. However, in order to achieve the same effect as the embodiment by increasing only “Vback2”, it is necessary to increase “Vback2” to approximately “250V”. However, in such cases, the electric field becomes stronger in a moving direction of the magnetic carrier whose charging polarity is an opposite polarity to the toner, from the developing device 4K to the photosensitive drum 1K, and the magnetic carrier moves to the photosensitive drum 1K and an amount of the magnetic carrier which is adhered is increased. In a case that the amount of the magnetic carrier adhering to the photosensitive drum 1K increases, a large amount of the magnetic carrier may accumulate in a drum cleaner 7K which collects the toner which remains on the photosensitive drum 1K after primary transfer. Then, a cleaner blade (unshown) in which the drum cleaner 7K includes may be damaged. Alternatively, when a surface of the photosensitive drum 1K is damaged by the magnetic carrier which is accumulated between the cleaner blade and the photosensitive drum 1K, an image defect which is caused by the damage may be occurred. Therefore, it is difficult to apply a method of increasing only “Vback2” to reduce the difference of the density.

In contrast, in the embodiment, “Vback2” during non-development is set to “210V or more and 230V or less”, for example. That is, in the embodiment, “Vback2” is suppressed to approximately “230V” during non-development, and in addition to increase “Vback2”, the peak-to-peak voltage “Vpp2” is also furthermore increased. By doing so, the amount of the magnetic carrier which contacts with the surface of the photosensitive drum 1K from the developing sleeve 203. Since a polarity of the magnetic carrier is an opposite polarity to the external additive, the external additive which remains on the photosensitive drum 1K is attached to the magnetic carrier and collected in the developer container 201 by the rotation of the developing sleeve 203. In this way, in the embodiment, by strengthening the electric field on the collecting side in “Vback2” compared to the comparative example 2 and increasing the peak-to-peak voltage “Vpp2”, an amount of the magnetic carrier which contacts on the photosensitive drum 1K is increased, so collection of the external additive which remains on the photosensitive drum 1K is actively carried out. Further, flying of the toner and the external additive caused by increasing the peak-to-peak voltage “Vpp2” is substantially suppressed by strengthening the electric field on the collection side due to “Vback2”. Therefore, in the embodiment, an amount of the external additive which remains on the photosensitive drum 1K does not increase.

As described above, in the embodiment, the peak-to-peak voltage (Vpp) and “Vback” are increased during non-development more than during development. In order to increase “Vback”, the DC voltage (Vdc2) of the developing voltage is set to be smaller in absolute value than during development. By doing so, the collection of the external additive from the photosensitive drum (from 1Y to 1K) by the electric field on the collection side due to “Vback” and the collection of the external additive from the photosensitive drum (from 1Y to 1K) by the magnetic carrier due to the peak-to-peak voltage “Vpp” are performed during non-development in an image forming job of forming an image on the recording material S. In this way, it is possible to suppress occurring an image defect caused by the external additive which is added to the toner.

### Second Embodiment

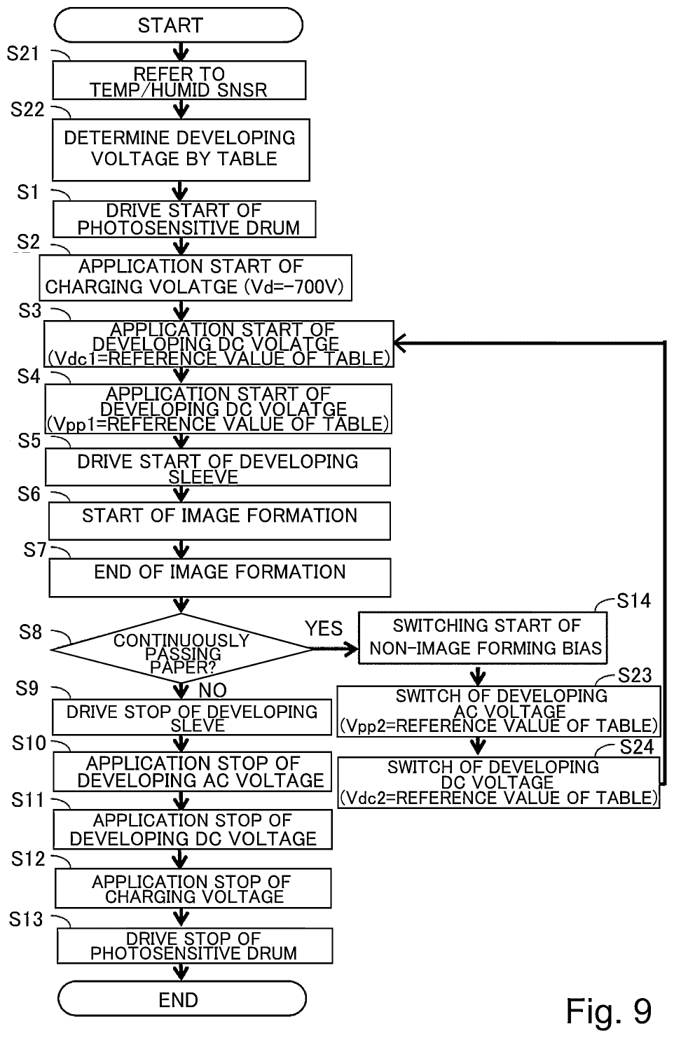

By the way, the inventors' experiments finds that the external additive tends to remain on the photosensitive drums (from 1Y to 1K) during development in a case that humidity is low rather than a case that humidity is high as an environment inside a main body of the image forming apparatus. This is because charging amount of the external additive is affected by humidity. That is, charging amount of the external additive is greater in a case that the humidity is low than a case that the humidity is high, and the amount of the external additive which remains on the photosensitive drums (from 1Y to 1K) tends to be increased. In consideration of this, it may be possible to securely collect the external additive on the photosensitive drums (from 1Y to 1K) by changing the developing voltage (Vpp and Vback) according to humidity. In the following, an “image forming process” according to a second embodiment in order to realize that will be described in FIG. 9. Incidentally, in the “image forming process” which is shown in FIG. 9, the same steps as in the “image forming process” according to the first embodiment (see FIG. 6) which is described above are numbered with the same step numbers, and a description will be simplified or omitted. Further, in the following, the image forming portion PY will be described as an example.

As shown in FIG. 9, when the control portion 101 receives a start command of a continuous image forming job from an unshown control portion, an external device, etc., the control portion 101 identifies the humidity inside the main body of the image forming apparatus based on a detection signal which is transmitted from the temperature and humidity sensor 110 (S21). And the control portion 101 determines the developing voltage (Vpp1, Vback1) which is applied during development and the developing voltage (Vpp2, Vback2) which is applied during non-development (S22), based on an environmental table which is shown in Table 2.

The environmental table is shown in Table 2. The environmental table which is shown in Table 2 specifies the values of the peak-to-peak voltage “Vpp1, Vpp2” and “Vback1, Vback2” for each humidity which is identified based on the detection signal (detection result) of the temperature and humidity sensor 110. The environmental table is stored in advance in the memory 103 (see FIG. 4). In Table 2, for example, the peak-to-peak voltage “1.60 kV, 1.80 kV” and the Vback “145V, 230V” are defined when humidity is less than 5%, and the peak-to-peak voltage “1.53 kV, 1.80 kV” and the Vback “147V, 220V” are specified when humidity is 5% or more and less than 20%.

TABLE 2

| Relative humidity | | | | |
|---|---|---|---|---|
| of image forming | | | | |
| apparatus [%] | Vpp1[kV] | Vpp2[kV] | Vback1[V] | Vback2[V] |
| less than 5 | 1.60 | 1.80 | 145 | 230 |
| 20 | 1.53 | 1.80 | 147 | 220 |
| 35 | 1.47 | 1.80 | 150 | 215 |
| 50 | 1.40 | 1.80 | 155 | 215 |
| 58 | 1.37 | 1.77 | 158 | 210 |
| 66 | 1.33 | 1.73 | 163 | 210 |
| 74 | 1.30 | 1.70 | 167 | 210 |
| more than 80 | 1.30 | 1.70 | 170 | 210 |

As shown in Table 2, the environmental table specifies greater values for both the peak-to-peak developing voltage “Vpp1, Vpp2” and the “Vback2” of the developing voltage for the low humidity side compared to the high humidity side, regardless of whether it is during development or non-developing. “Vback2” during non-development is, for example, “210V or more and 230 V or less”.

The control portion 101 controls a driving motor and starts rotational driving of the photosensitive drum 1Y (S1). The control portion 101 controls the charging bias power source 81 and starts applying the charging voltage (S2). And the control portion 101 controls the developing bias power source 82 and starts applying the developing voltage during development (S3, S4). At this time, the control portion 101 controls the developing bias power source 82 to apply the developing voltage during development according to the peak-to-peak voltage “Vpp1” and “Vback1” which are determined according to the humidity which is described above. For example, in a case that the humidity is “52%”, the developing voltage is applied in which the peak-to-peak voltage “Vpp1” is “1.37 kV” and “Vback1” is “158V” according to the environmental table in Table 2. After the control portion 101 starts the rotational driving of the developing sleeve 203 (S5), the control portion 101 starts conveying the recording material S and performs image formation on the recording material S (S6). Each time completing to perform image formation on one sheet of the recording material S (S7), the control portion 101 determines whether or not there is a subsequent recording material S which is continuously image formed (S8).

In a case that there is no subsequent recording material S (NO in S8), the control portion 101 stops the rotational driving of the developing sleeve 203 (S9). Further, the control portion 101 stops applying the AC voltage and the DC voltage by the developing bias power source 82 (S10, S11). And the control portion 101 stops applying the charging voltage by the charging bias power source 81 (S12), then the control portion 101 stops the rotational driving of the photosensitive drum 1Y (S13), and terminates the image forming process.

On the other hand, in a case that there is a subsequent recording material S (S8 YES), the control portion 101 switches a developing voltage to the developing voltage which is applied during non-development (S14). At this time, the control portion 101 controls the developing bias power source 82 to apply the developing voltage during non-development according to the peak-to-peak voltage “Vpp2” and “Vback2” which are determined according to the humidity which is described above (S23, S24). For example, in a case that humidity is “52%”, the developing voltage is applied in which the peak-to-peak voltage “Vpp2” is “1.77 kV” and “Vback2” is “210V” according to the environmental table in Table 2. In a case that humidity is “33%”, the developing voltage is applied in which the peak-to-peak voltage “Vpp2” is “1.80 kV” and “Vback2” is “215V”, according to the environmental table in Table 2. That is, in a case that relative humidity is a second humidity (33%) which is lower than a first humidity (52%), the peak-to-peak voltage is set to “1.77 kV” (a third peak-to-peak voltage) which is greater than “1.37 kV” (a second peak-to-peak voltage). Further, the DC voltage is set to a DC voltage (a third DC voltage) with a smaller absolute value in which “Vback2” is “215V” rather than the DC voltage (a second DC voltage) in which “Vback1” is “158V”. After that, the control portion 101 returns to the process of the step S3 in order to return to the developing voltage during development for a subsequent recording material S.

In this way, in the second embodiment, the peak-to-peak voltage (Vpp2) and “Vback2” which are applied during non-development is possible to be controlled according to a detection result of the temperature and humidity sensor 110. That is, the peak-to-peak voltage (Vpp2) and the DC voltage (Vdc2) are controlled to be appropriate to collect the external additive from the photosensitive drum 1Y according to the amount of the external additive which remains on the photosensitive drum 1Y which is possible to vary depending on humidity. Therefore, it is possible to realize efficiently to suppress occurring an image defect which is caused by the external additive, regardless of the humidity inside the main body of the image forming apparatus.

### Other Embodiment

Incidentally, in the embodiment which is described above, the peak-to-peak voltage of the AC voltage is controlled, however, it is not limited to this. In addition to the peak-to-peak voltage, for example, a duty ratio of the AC voltage may be further controlled. A case of controlling the duty ratio of the AC voltage is shown in Table 3 below. Incidentally, in the specification, a duty ratio is a ratio of time in which a maximum voltage is applied in one cycle which is a sum of time in which the maximum voltage (AC voltage with the same charging polarity as the toner's charging polarity with respect to the DC voltage) and time in which minimum voltage (AC voltage with the opposite polarity of the toner's charging polarity with respect to the DC voltage) in the AC bias portion which is shown in part (a) of FIG. 5.

TABLE 3

| | during development | during non-development |
|---|---|---|
| duty ratio | 60% | 65% |

As shown in Table 3, a duty ratio of the AC voltage is set to a first duty ratio (for example, 60%) during development, and a duty ratio of the AC voltage is set to a second duty ratio (for example, 65%) during non-development, which is higher than the first duty ratio. In a case that the duty ratio of the AC voltage is made greater, time for the magnetic carrier to contact a side of the photosensitive drum 1Y from the developer container 201 increases. Therefore, it is easier to collect the toner via the magnetic carrier during non-development and to remove the external additive on the photosensitive drum 1Y.

Incidentally, in the embodiments which are described above, the image forming apparatus 100 of an intermediary transfer method, in which the toner image is secondarily transferred from the intermediary transfer belt 5 to the recording material S after primary transfer of the toner image from the photosensitive drums from 1Y to 1K of each color to the intermediary transfer belt 5, is described as an example, however, it is not limited to this.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-191063 filed on Nov. 8, 2023, which is hereby incorporated by reference herein in its entirety.

What is claimed is:

1. An image forming apparatus comprising:
an image bearing member;
a charging portion configured to charge the image bearing member to a predetermined charging potential;
a latent image forming portion configured to form an electrostatic latent image on the image bearing member charged to the predetermined charging potential by the charging portion;
a developer bearing member configured to bear and feed a developer including toner and an external additive having the same polarity as a charging polarity of the toner in a developing area where the electrostatic laten image formed on the image bearing member by the latent image forming portion is developed; and
a developing bias application portion configured to apply a developing bias in which a DC voltage is superposed with an AC voltage to the developer bearing member,
wherein in a case where in a continuous image forming job in which the image is formed on a plurality of recording materials including a first recording material and a second recording material subsequent to the first recording material,
a period from when a leading end of a first electrostatic latent image for the first recording material passes through the developing area until a trailing end of the first electrostatic latent image passes through the developing area is defined as a first period, and
a period from when the trailing end of the first electrostatic latent image passes through the developing area until a leading end of a second electrostatic latent image for the second recording material passes through the developing area, and the latent image forming portion does not form the electrostatic latent image on the image bearing member is defined as a second period,
the developing bias application portion applies the developing bias to the developer bearing member so that an absolute value of a difference between the predetermined charging potential and the DC voltage in the second period is larger than an absolute value of a difference between the predetermined charging potential and the DC voltage in the first period, and a peak-to-peak voltage of the AC voltage in the second period is larger than a peak-to-peak voltage of the AC voltage in the first period.

2. The image forming apparatus according to claim 1, wherein a polarity of the DC voltage in the first period and a polarity of the DC voltage in the second period are the same polarity of the charging polarity of the toner, and
wherein the absolute value of the DC voltage in the second period is smaller than the absolute value of the DC voltage in the first period.

3. The image forming apparatus according to claim 1, further comprising a humidity sensor configured to detect a humidity,
wherein the developing bias application portion applies the developing bias to the developer bearing member so that an absolute value of a difference between the predetermined charging potential and the DC voltage in the second period and in a case where the humidity detected by the humidity sensor is a second humidity lower than a first humidity is larger than an absolute value of a difference between the predetermined charging potential and the DC voltage in the second period and in a case where the humidity detected by the humidity sensor is the first humidity, and
so that the peak-to-peak voltage of the AC voltage in the second period and in a case where the humidity detected by the humidity sensor is the second humidity is larger than the peak-to-peak voltage of the AC voltage in the second period and in a case where the humidity detected by the humidity sensor is the first humidity.

4. The image forming apparatus according to claim 1, wherein in a case where a time when, of AC voltage, a voltage having the same polarity as the charging polarity of the toner to the DC voltage is applied is defined as a first application time, a time when, of AC voltage, a voltage having a polarity opposite to the charging polarity of the toner to the DC voltage is applied is defined as a second application time, and a ratio occupied by the first application time of one period which is a sum of the first application time and the second application time is defined as a duty ratio,
the developing bias application portion applies the developing bias to the developer bearing member so that the duty ratio in the second period is larger than the duty ratio in the first period.
